(19) United States
(12) Patent Application Publication
(10) Pub. No.: US 2025/0268269 A1
(43) Pub. Date: Aug. 28, 2025

(54) COMPOSITION AND METHOD FOR PRESERVING FISH

(71) Applicant: Sergey Nikolenko, Carlsbad, CA (US)

(72) Inventor: Sergey Nikolenko, Carlsbad, CA (US)

(21) Appl. No.: 18/774,805

(22) Filed: Jul. 16, 2024

Related U.S. Application Data
(60) Provisional application No. 63/558,916, filed on Feb. 28, 2024.

(51) Int. Cl. A23B 4/09; A23B 4/027; A23B 4/18

(52) U.S. Cl. CPC A23B 4/09; A23B 4/027; A23B 4/18

(57) ABSTRACT

The present disclosure provides a fish preservation composition comprising an antioxidant, an antimicrobial agent, and a pH modifier. The composition is an aqueous solution comprising sodium acetate, sodium citrate, sodium bicarbonate, sodium ascorbate, and sodium nitrite. A method for preserving fish includes preparing the fish, immersing the fish in the preservation composition, removing the fish from the composition, and packaging and storing the treated fish. A system for preserving fish includes a container holding the fish preservation composition and an administrative device for applying the composition to fish. The composition, method, and system extend shelf life and maintain quality of fresh or frozen fish.

### CROSS-REFERENCE TO RELATED APPLICATIONS

This application claims priority from U.S. Provisional Application Ser. No. 63/558,916 filed on Feb. 28, 2024, which is incorporated herein by reference in its entirety.

### STATEMENT REGARDING FEDERALLY SPONSORED RESEARCH OR DEVELOPMENT

Not Applicable.

### FIELD

The present disclosure relates to fish preservation, and more particularly to a composition and method for extending the shelf life of fresh or frozen fish while maintaining texture, color and quality.

### INTRODUCTION

The conservation of perishable foodstuffs, such as meat, fish, and various comestibles, poses a significant challenge for stakeholders within the food industry, including food processors, distributors, and retailers. Historically, humans employed techniques such as salting and dehydration to prolong the shelf life of these food items. Later, preservation methods evolved to include freezing, canning, and refrigeration. These advanced preservation techniques have facilitated the extended storage and distribution of meat and fish products, allowing for their transport over greater temporal and geographical distances.

The most prevalent technique employed for extending the shelf life of fish beyond a short duration is freezing. However, a fundamental issue associated with freezing fish is the alteration of their sensory attributes often associated with “freshness,” notably the retention of a maroon or red color in the flesh. This change in coloration arises due to the oxidation of the Fe+ ion in the heme pigment found within the myoglobin of the flesh. The consequential loss of these sensory attributes diminishes the market value of frozen fish in comparison to their non-frozen counterparts.

Consumers tend to base their choices primarily on visual cues, rather than relying on other sensory factors such as aroma, taste, or texture. Consequently, it is highly desirable to maintain the “fresh” maroon or red color of these products for as long as possible, both to command a premium price in the market and to potentially restore these colors following the freezing and thawing processes.

Various techniques have been employed to address the issue of color retention and shelf life extension in fish preservation. These include smoking, carbon monoxide treatment, and super-frozen technologies. However, each of these methods has its own limitations and drawbacks. Smoking, while effective in extending shelf life, alters the natural flavor of the fish. Carbon monoxide treatment, though capable of maintaining red coloration, raises concerns about potentially masking spoilage. Super-frozen technologies, while highly effective in preserving quality, are often cost-prohibitive and require specialized infrastructure.

Therefore, there remains a need in the food industry for improved methods and compositions for fish preservation that can effectively maintain the natural color, texture, and flavor of fish while extending its shelf life, without the drawbacks associated with existing preservation techniques.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a fish preservation composition is provided. The composition includes an antioxidant, an antimicrobial agent, and a pH modifier, wherein the composition is an aqueous solution comprising sodium acetate, sodium citrate, sodium bicarbonate, sodium ascorbate, and sodium nitrite.

According to other aspects of the present disclosure, the fish preservation composition may include one or more of the following features. The sodium acetate may be present in a range of 3% to 5% by weight of the composition. The sodium citrate may be present in a range of 1.5% to 3.5% by weight of the composition. The sodium bicarbonate may be present in a range of 0.5% to 2% by weight of the composition. The sodium ascorbate may be present in a range of 0.1% to 1.5% by weight of the composition. The sodium nitrite may be present in a range of 0.1% to 1% by weight of the composition. The composition may further include an administrative device selected from a prefilled syringe for use in manual injection or auto injection.

According to another aspect of the present disclosure, a method for preserving fish is provided. The method includes preparing the fish in a desired size and portion, immersing the fish in an effective amount of a preservation composition for a predetermined time and temperature, wherein the preservation composition comprises an antioxidant, an antimicrobial agent, and a pH modifier, removing the fish from the composition, and packaging and storing the treated fish.

According to other aspects of the present disclosure, the method may include one or more of the following features. The preservation composition may be an aqueous solution comprising sodium acetate, sodium citrate, sodium bicarbonate, sodium ascorbate, and sodium nitrite. The sodium acetate may be present in a range of 3% to 5% by weight of the composition, the sodium citrate may be present in a range of 1.5% to 3.5% by weight of the composition, the sodium bicarbonate may be present in a range of 0.5% to 2% by weight of the composition, the sodium ascorbate may be present in a range of 0.1% to 1.5% by weight of the composition, and the sodium nitrite may be present in a range of 0.1% to 1% by weight of the composition. The step of preparing the fish may comprise filleting the fish into loins and trimming to remove excess fat, bones, skin, and blood lines. The predetermined time may be about one hour and the predetermined temperature may be about +34° F. The step of packaging may comprise vacuum sealing the treated fish. The method may further include a step of storing the vacuum sealed treated fish at a temperature between +33° F. and +35° F. for about 24 hours. The method may further include a step of freezing the vacuum sealed treated fish to a temperature of about −35° F.

According to another aspect of the present disclosure, a system for preserving fish is provided. The system includes a container for holding a fish preservation composition, a fish preservation composition disposed within the container, the composition comprising an antioxidant, an antimicrobial agent, and a pH modifier, and an administrative device for applying the fish preservation composition to fish.

According to other aspects of the present disclosure, the system may include one or more of the following features. The fish preservation composition may be an aqueous solution comprising sodium acetate, sodium citrate, sodium bicarbonate, sodium ascorbate, and sodium nitrite. The sodium acetate may be present in a range of 3% to 5% by weight of the composition, the sodium citrate may be present in a range of 1.5% to 3.5% by weight of the composition, the sodium bicarbonate may be present in a range of 0.5% to 2% by weight of the composition, the sodium ascorbate may be present in a range of 0.1% to 1.5% by weight of the composition, and the sodium nitrite may be present in a range of 0.1% to 1% by weight of the composition. The administrative device may be selected from a prefilled syringe for manual injection or an auto injector. The system may further include a refrigeration unit configured to maintain the fish preservation composition at a temperature between +33° F. and +35° F.

The foregoing general description of the illustrative embodiments and the following detailed description thereof are merely exemplary aspects of the teachings of this disclosure and are not restrictive.

### BRIEF DESCRIPTION OF DRAWINGS

Not Applicable.

### DETAILED DESCRIPTION

### Composition and Method for Preserving Fish

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a composition and method for preserving fish, particularly fresh or frozen tuna, that may extend the product's shelf life while maintaining its sensory attributes such as color, texture, and flavor. The disclosed composition may comprise a combination of an antioxidant, an antimicrobial agent, and a pH control agent. In some embodiments, the antioxidant may be sodium ascorbate, while the antimicrobial agent and pH control agent may include sodium acetate, sodium citrate, sodium bicarbonate, and sodium nitrite. These components may work synergistically to inhibit microbial growth, control pH, and prevent oxidation, thereby preserving the freshness, color, and flavor of the fish.

In some embodiments, the fish preservation method may involve immersing the fish in the composition for a predetermined period. In other embodiments, the method may include injecting the fish with the composition. The treated fish may then be packaged and stored under specific conditions to further extend its shelf life.

The disclosed composition and method may offer a solution to the challenge of preserving the quality of fish products during storage and transportation, without the use of carbon monoxide or other potentially harmful substances. This approach may allow for the delivery of high-quality fish products to consumers, with the taste, texture, and appearance reminiscent of freshly caught fish.

In some aspects, the fish preservation composition may comprise an antioxidant, an antimicrobial agent, and a pH modifier. The antioxidant may serve to inhibit the oxidation of fats and proteins in the fish, thereby preserving its freshness and color. In some cases, the antioxidant may be sodium ascorbate, a powerful antioxidant known for its ability to prevent the breakdown of lipids and proteins that can lead to rancidity and loss of flavor.

The antimicrobial agent in the composition may function to inhibit the growth of spoilage microorganisms in the fish, thereby extending its shelf life. In some embodiments, the antimicrobial agent may be selected from sodium acetate, sodium citrate, and sodium nitrite. Sodium acetate and sodium citrate may act as acidity regulators, inhibiting the growth of spoilage microorganisms and making the fish safe to consume for a longer period. Sodium nitrite may prevent the growth of harmful bacteria, such as Clostridium botulinum, which can produce toxins responsible for foodborne illnesses. Additionally, sodium nitrite may impart and maintain a pinkish-red color in the fish, enhancing its visual appeal.

The pH modifier in the composition may serve to stabilize the pH of the fish, which can further inhibit microbial growth and extend the shelf life of the fish. In some cases, the pH modifier may be selected from sodium acetate, sodium citrate, and sodium bicarbonate. These compounds may function to regulate the acidity of the fish, creating an environment that is unfavorable for bacterial growth.

In some embodiments, the fish preservation composition may be an aqueous solution comprising sodium acetate, sodium citrate, sodium bicarbonate, sodium ascorbate, and sodium nitrite. The specific concentrations of these components may vary depending on the desired preservation effect. For instance, the concentration of sodium acetate may be in the range of 3-5%, sodium citrate in 1.5-3.5%, sodium bicarbonate in 0.5-2%, sodium ascorbate in 0.1-1.5%, and sodium nitrite in 0.1-1%.

In some cases, the fish preservation composition may be used to treat a variety of fish species, including but not limited to tuna, salmon, cod, and haddock. The composition may be particularly effective in preserving the quality of fresh or frozen tuna, a fish species known for its high market value and distinctive sensory attributes.

In some aspects, the composition for preserving fish may include specific components such as sodium acetate, sodium citrate, sodium bicarbonate, sodium ascorbate, and sodium nitrite. Sodium acetate (CH3COONa), which may function as a pH or acidity regulator, may inhibit the growth of spoilage microorganisms in fish, potentially making the product safe to consume for a longer period. Sodium acetate is generally recognized as safe and may be used without restrictions in the food industry.

Sodium citrate (Na3C6H5O7) may serve as an agent that regulates acidity, prevents oxidation, and inhibits microbial growth. This compound may contribute to the preservation of the fish by creating an environment that is unfavorable for bacterial growth, thereby extending the shelf life of the fish.

Sodium bicarbonate (NaHCO3) is a compound with a mild alkaline flavor that may be used in food manufacturing. It may exhibit properties that inhibit microbial growth and stabilize pH, further contributing to the preservation of the fish.

Sodium ascorbate (C6H7NaO6) may function as a powerful antioxidant in the composition. Its use may inhibit the oxidation of fats and proteins in raw fish, thereby preserving the freshness and color of the fish and preventing it from becoming discolored or developing off-flavors due to exposure to oxygen. Sodium ascorbate may also preserve the natural flavors of raw fish by reducing oxidation, which can lead to the breakdown of lipids and proteins, resulting in rancidity and loss of flavor.

Sodium nitrite (NaNO2) may serve as an agent that prevents the growth of harmful bacteria, such as Clostridium botulinum, which can produce toxins responsible for foodborne illnesses. Sodium nitrite may also impart and maintain a pinkish-red color in the fish, enhancing its visual appeal. Furthermore, sodium nitrite may act as an antioxidant, preventing the oxidation of fats and proteins in the fish. By reducing oxidation, it may extend the shelf life of the fish and maintain its quality.

In some cases, the concentrations of these components in the composition may vary depending on the desired preservation effect. For instance, the concentration of sodium acetate may be in the range of 3-5%, sodium citrate in 1.5-3.5%, sodium bicarbonate in 0.5-2%, sodium ascorbate in 0.1-1.5%, and sodium nitrite in 0.1-1%. These ranges may provide flexibility in formulating the composition to achieve optimal preservation results for different types of fish or different storage conditions.

In some aspects, the fish preservation composition may include specific concentrations of each component to achieve the desired preservation effect. For instance, the sodium acetate may be present in a range of 3% to 5% by weight of the composition. Sodium acetate, as a pH or acidity regulator, may inhibit the growth of spoilage microorganisms in fish, potentially extending the product's shelf life.

In some cases, the sodium citrate may be present in a range of 1.5% to 3.5% by weight of the composition. Sodium citrate, as an agent that regulates acidity and inhibits microbial growth, may contribute to the preservation of the fish by creating an environment that is unfavorable for bacterial growth.

In other embodiments, the sodium bicarbonate may be present in a range of 0.5% to 2% by weight of the composition. Sodium bicarbonate, with its mild alkaline flavor and properties that inhibit microbial growth and stabilize pH, may further contribute to the preservation of the fish.

In yet other embodiments, the sodium ascorbate may be present in a range of 0.1% to 1.5% by weight of the composition. Sodium ascorbate, as a powerful antioxidant, may inhibit the oxidation of fats and proteins in raw fish, thereby preserving the freshness and color of the fish and preventing it from becoming discolored or developing off-flavors due to exposure to oxygen.

In some embodiments, the sodium nitrite may be present in a range of 0.1% to 1% by weight of the composition. Sodium nitrite, as an agent that prevents the growth of harmful bacteria and imparts and maintains a pinkish-red color in the fish, may enhance the visual appeal of the fish and extend its shelf life.

These specific concentration ranges may provide flexibility in formulating the composition to achieve optimal preservation results for different types of fish or different storage conditions. In some cases, the concentrations may be adjusted within these ranges to tailor the composition to the specific needs of the fish to be preserved.

In some aspects, the components of the fish preservation composition may work together to preserve the fish by inhibiting microbial growth, controlling pH, and preventing oxidation. Sodium acetate, sodium citrate, and sodium bicarbonate may function as pH modifiers, creating an environment that is unfavorable for bacterial growth. By inhibiting the growth of spoilage microorganisms, these components may extend the shelf life of the fish.

In addition to their role as pH modifiers, sodium acetate and sodium citrate may also serve as antimicrobial agents. These compounds may inhibit the growth of harmful bacteria, such as Clostridium botulinum, which can produce toxins responsible for foodborne illnesses. By preventing the growth of these bacteria, the antimicrobial agents may further contribute to the preservation of the fish.

Sodium ascorbate, as an antioxidant, may inhibit the oxidation of fats and proteins in the fish. Oxidation can lead to discoloration and the development of off-flavors in the fish. By preventing oxidation, sodium ascorbate may preserve the freshness, color, and flavor of the fish.

Sodium nitrite may serve multiple roles in the composition. As an antimicrobial agent, it may prevent the growth of harmful bacteria. As an antioxidant, it may prevent the oxidation of fats and proteins in the fish. Additionally, sodium nitrite may impart and maintain a pinkish-red color in the fish, enhancing its visual appeal.

In some cases, the fish preservation composition may be applied to the fish by immersing the fish in the composition for a predetermined period. This method may allow for the components of the composition to penetrate the fish and exert their preservation effects. In other cases, the composition may be injected into the fish, which may provide a more direct and efficient method of application.

In some embodiments, the treated fish may be packaged and stored under specific conditions to further extend its shelf life. For instance, the fish may be vacuum-sealed to create a sealed environment that may further inhibit microbial growth. The fish may then be stored at a specific temperature range, such as between +33° F. and +35° F., to maintain the quality of the fish over time.

In some aspects, the fish preservation composition and method may be used to preserve a variety of fish species, including but not limited to tuna, salmon, cod, and haddock. The specific concentrations of the components in the composition may be adjusted depending on the specific needs of the fish species to be preserved. For instance, the concentration of sodium acetate may be increased for fish species that are more susceptible to spoilage by certain microorganisms, while the concentration of sodium ascorbate may be decreased for fish species that are less prone to oxidation.

In some aspects, the fish preservation composition may further comprise an administrative device. The administrative device may be selected from a variety of devices suitable for applying the composition to the fish. In some cases, the administrative device may be a prefilled syringe that can be used for manual injection of the composition into the fish. The prefilled syringe may allow for precise control over the amount of composition applied and the location of application, which may be beneficial for preserving specific parts of the fish or for treating smaller fish species.

In other cases, the administrative device may be an auto injector. The auto injector may be a device that automatically injects the composition into the fish, potentially reducing the time and effort required for the preservation process. The auto injector may be particularly useful for treating larger quantities of fish or larger fish species, where manual injection may be time-consuming or impractical.

In some embodiments, the administrative device may be designed to deliver the composition in a specific manner to achieve optimal preservation results. For instance, the device may be configured to deliver the composition at a specific depth within the fish, or to distribute the composition evenly throughout the fish. The specific design and configuration of the administrative device may be tailored to the specific needs of the fish to be preserved and the desired preservation effect.

In some cases, the administrative device may be reusable or disposable, depending on the specific needs of the preservation process. A reusable device may be cleaned and sterilized after each use, while a disposable device may be discarded after a single use. The choice between a reusable or disposable device may depend on factors such as the cost of the device, the volume of fish to be preserved, and the specific requirements of the preservation process.

In some aspects, a method for preserving fish may involve several steps, including preparing the fish, immersing the fish in the preservation composition, removing the fish from the composition, and packaging and storing the treated fish. The preparation of the fish may involve cleaning the fish and cutting it into a desired size and portion. The size and portion of the fish may be determined based on factors such as the type of fish, the intended use of the fish, and the specific requirements of the preservation process.

The immersion of the fish in the preservation composition may involve placing the fish in a container filled with the composition. The fish may be fully submerged in the composition to ensure that all parts of the fish come into contact with the composition. The duration of the immersion may be predetermined and may vary depending on factors such as the type of fish, the size and portion of the fish, and the specific components of the preservation composition. In some cases, the fish may be immersed in the composition for about one hour.

Following the immersion, the fish may be removed from the preservation composition. The removal of the fish may involve lifting the fish out of the container and allowing any excess composition to drain off. The fish may then be rinsed or wiped to remove any remaining composition on the surface of the fish.

The packaging of the treated fish may involve placing the fish in a suitable container or packaging material. In some cases, the fish may be vacuum-sealed to create a sealed environment that may further inhibit microbial growth. The vacuum-sealing process may involve placing the fish in a vacuum bag, removing the air from the bag, and sealing the bag to create a vacuum inside.

The storing of the treated fish may involve placing the packaged fish in a storage area maintained at a specific temperature range. In some cases, the storage area may be a refrigerator or freezer maintained at a temperature between +33° F. and +35° F. The fish may be stored in this manner for a predetermined period, which may be determined based on factors such as the type of fish, the specific components of the preservation composition, and the desired shelf life of the fish.

In some embodiments, the ratio of the liquid composition to the fish may be about 65% liquid to 35% fish. This ratio may provide an optimal balance between the amount of preservation composition used and the amount of fish treated, potentially maximizing the preservation effect while minimizing the use of the composition. The specific ratio may be adjusted depending on factors such as the type of fish, the size and portion of the fish, and the specific components of the preservation composition.

In some aspects, the process of preparing the fish for preservation may involve filleting the fish into loins and trimming to remove excess fat, bones, skin, and blood lines. The filleting process may involve separating the meat of the fish from the bones and skin, resulting in four loins, including two back loins and two belly loins. This process may be performed manually or using a filleting machine, depending on the size and type of the fish and the volume of fish to be processed.

In some cases, the loins may be further trimmed to remove excess fat and any remaining bones. This trimming process may enhance the culinary experience by removing parts of the fish that may affect its taste or texture. The trimming process may be performed manually using a knife or other cutting tool, or it may be automated using a trimming machine.

In some embodiments, if the loins are found to be too thick, such as thicker than 4 inches at any dimension, they may be subsequently cut into smaller portions, such as steaks. This additional cutting step may allow for better penetration of the preservation composition into the fish, potentially enhancing the preservation effect. The cutting process may be performed manually using a knife or other cutting tool, or it may be automated using a cutting machine.

In other embodiments, the fish may be prepared in different sizes and portions depending on the specific needs of the preservation process and the intended use of the fish. For instance, the fish may be cut into smaller pieces for use in sushi or other dishes, or it may be left in larger portions for use in grilling or baking. The specific size and portion of the fish may be determined based on factors such as the type of fish, the desired shelf life of the fish, and the specific components of the preservation composition.

In some aspects, the fish preservation method may involve immersing the fish in the preservation composition for a predetermined period at a specific temperature. For instance, the fish may be immersed in the composition for about one hour at a temperature of about +34° F. This immersion process may allow the components of the composition to penetrate the fish and exert their preservation effects. The specific duration and temperature of the immersion may be adjusted depending on factors such as the type of fish, the size and portion of the fish, and the specific components of the preservation composition. In some cases, the immersion may be performed in a controlled environment, such as a refrigerated room or a temperature-controlled tank, to maintain the desired temperature throughout the immersion period. In other cases, the immersion may be performed at ambient temperature, with the temperature of the composition being adjusted as needed to achieve the desired preservation effect.

In some aspects, the method for preserving fish may involve packaging the treated fish after it has been immersed in the preservation composition and removed. The packaging process may be designed to further extend the shelf life of the fish and maintain its quality during storage and transportation. In some cases, the packaging process may involve vacuum sealing the treated fish. Vacuum sealing may create a sealed environment that inhibits the growth of spoilage microorganisms, thereby further extending the shelf life of the fish.

In some embodiments, the vacuum sealing process may involve placing the treated fish in a vacuum bag, removing the air from the bag, and sealing the bag to create a vacuum inside. This process may effectively seal the fish within the bag, preventing exposure to air and inhibiting the growth of spoilage microorganisms. The vacuum sealing process may be performed using a vacuum sealer, which may be a manual or automated device designed to remove air from the bag and seal it.

In other embodiments, the vacuum sealing process may involve other methods or devices for creating a vacuum within the packaging. For instance, the vacuum sealing process may involve the use of a vacuum chamber, a vacuum pump, or other vacuum generating devices. The specific method or device used for vacuum sealing may depend on factors such as the size and type of the fish, the volume of fish to be packaged, and the specific requirements of the preservation process.

In some cases, the vacuum sealed fish may be further packaged in secondary packaging materials for additional protection during storage and transportation. The secondary packaging materials may include boxes, crates, or other suitable containers. The specific type of secondary packaging material may be selected based on factors such as the size and type of the fish, the volume of fish to be packaged, and the specific requirements of the storage and transportation process.

In some aspects, the vacuum sealed fish may be labeled with information such as the type of fish, the date of packaging, the expiration date, and other relevant information. The labeling process may involve the use of labels, tags, or other suitable marking devices. The specific information included on the label may be determined based on regulatory requirements, consumer preferences, and other relevant factors.

In some embodiments, the vacuum sealed fish may be stored in a specific manner to further extend its shelf life and maintain its quality. The storage process may involve placing the vacuum sealed fish in a storage area maintained at a specific temperature range, such as between +33° F. and +35° F. The fish may be stored in this manner for a predetermined period, which may be determined based on factors such as the type of fish, the specific components of the preservation composition, and the desired shelf life of the fish.

In some embodiments, after the fish has been treated with the preservation composition and removed from it, the treated fish may be packaged and stored under specific conditions to further extend its shelf life. For instance, the treated fish may be vacuum-sealed in bulk and placed in a chiller maintained at a temperature range of +33 to +35° F. for a duration of 24 hours. This cooling period may allow the components of the preservation composition to distribute evenly throughout the meat, enhancing their effectiveness in preserving the fish.

In some cases, after this 24-hour period, the treated fish may be individually vacuum-sealed and optionally subjected to Individually Quick Freezing (IQF) until reaching a temperature of −35° F. This freezing process may further extend the shelf life of the fish by slowing down the metabolic processes that lead to spoilage. The freezing temperature of −35° F. may be particularly effective in preserving the quality of the fish, as it may bring all chemical and biological activities to a complete halt, preventing any degradation from occurring.

In some aspects, the treated fish may be preserved for up to twenty-four months in a frozen state. This extended shelf life may allow for the transportation and distribution of the fish over greater temporal and geographical distances, potentially expanding the market reach of the fish products.

In some cases, the treated fish may maintain its quality for approximately seventy-two hours after defrosting. This extended defrosted shelf life may provide consumers with a longer window of time to consume the fish while it is still fresh, potentially enhancing the consumer experience and increasing the market value of the fish.

In some embodiments, the specific storage conditions, including the temperature and duration of storage, may be adjusted depending on factors such as the type of fish, the size and portion of the fish, and the specific components of the preservation composition. For instance, fish species that are more susceptible to spoilage may be stored at lower temperatures or for shorter durations, while larger portions of fish may require longer storage durations to allow for the even distribution of the preservation composition.

In some aspects, a system for preserving fish may be provided. The system may include a container for holding a fish preservation composition, a fish preservation composition disposed within the container, and an administrative device for applying the fish preservation composition to fish. The container may be any suitable container capable of holding the fish preservation composition and the fish to be preserved. In some cases, the container may be a tank, a vat, a basin, or any other suitable container. The size and shape of the container may be selected based on factors such as the size and type of the fish, the volume of fish to be preserved, and the specific requirements of the preservation process.

The fish preservation composition disposed within the container may be as described above. In some embodiments, the composition may be an aqueous solution comprising sodium acetate, sodium citrate, sodium bicarbonate, sodium ascorbate, and sodium nitrite. The specific concentrations of these components in the composition may vary depending on the desired preservation effect. For instance, the concentration of sodium acetate may be in the range of 3% to 5% by weight of the composition, the concentration of sodium citrate may be in the range of 1.5% to 3.5% by weight of the composition, the concentration of sodium bicarbonate may be in the range of 0.5% to 2% by weight of the composition, the concentration of sodium ascorbate may be in the range of 0.1% to 1.5% by weight of the composition, and the concentration of sodium nitrite may be in the range of 0.1% to 1% by weight of the composition.

The administrative device for applying the fish preservation composition to fish may be selected from a variety of devices suitable for applying the composition to the fish. In some cases, the administrative device may be a prefilled syringe that can be used for manual injection of the composition into the fish. The prefilled syringe may allow for precise control over the amount of composition applied and the location of application, which may be beneficial for preserving specific parts of the fish or for treating smaller fish species. In other cases, the administrative device may be an auto injector. The auto injector may be a device that automatically injects the composition into the fish, potentially reducing the time and effort required for the preservation process. The auto injector may be particularly useful for treating larger quantities of fish or larger fish species, where manual injection may be time-consuming or impractical.

In some embodiments, the system for preserving fish may further include a refrigeration unit. The refrigeration unit may be configured to maintain the fish preservation composition at a specific temperature range, such as between +33° F. and +35° F. This temperature range may be optimal for the preservation of the fish, as it may inhibit the growth of spoilage microorganisms and slow down the metabolic processes that lead to spoilage. The refrigeration unit may be a standalone unit, or it may be integrated with the container for holding the fish preservation composition. In some cases, the refrigeration unit may include a temperature control system that allows for the precise control of the temperature within the unit. The temperature control system may include a thermostat, a temperature sensor, a heating element, a cooling element, or any combination thereof. The refrigeration unit may also include an insulation layer to minimize heat transfer and maintain the desired temperature within the unit. In some embodiments, the refrigeration unit may be powered by electricity, but in other cases, it may be powered by other energy sources such as gas or solar power. The specific design and configuration of the refrigeration unit may be tailored to the specific needs of the preservation process, including the type of fish to be preserved, the volume of fish to be preserved, and the specific components of the preservation composition.

In some aspects, the effectiveness of the fish preservation composition and method may be demonstrated through various examples or case studies. For instance, a study may be conducted to evaluate the shelf life and quality of fresh or frozen tuna treated with the preservation composition. The study may involve treating a batch of tuna with the composition, packaging and storing the treated tuna under specific conditions, and periodically assessing the quality of the tuna over time. The quality assessment may include evaluating the color, texture, and flavor of the tuna, as well as testing for the presence of spoilage microorganisms. The results of the study may provide empirical evidence of the effectiveness of the preservation composition and method in extending the shelf life of the tuna and maintaining its quality.

In one example, a batch of fresh caught tuna may be filleted into four loins, trimmed to remove excess fat and bones, and then treated with the preservation composition. The composition may be an aqueous solution comprising sodium acetate, sodium citrate, sodium bicarbonate, sodium ascorbate, and sodium nitrite, with specific concentrations of each component as described above. The treated tuna may be vacuum-sealed in bulk and placed in a chiller maintained at a temperature range of +33 to +35° F. for 24 hours. After this cooling period, the tuna may be individually vacuum-sealed and subjected to Individually Quick Freezing (IQF) until reaching a temperature of −35° F. The frozen tuna may be stored for up to twenty-four months, and its quality may be assessed periodically throughout this storage period.

In another example, a batch of frozen tuna may be defrosted and treated with the preservation composition. The defrosted tuna may be cut into smaller portions, such as cubes or strips, before being treated with the composition. The treated tuna may be vacuum-sealed and stored in a refrigerator maintained at a temperature range of +33 to +35° F. The quality of the refrigerated tuna may be assessed periodically over a period of about 72 hours. The assessment may include evaluating the color, texture, and flavor of the tuna, as well as testing for the presence of spoilage microorganisms.

In both examples, the treated tuna may maintain its vibrant red or bright color, enhancing its visual appeal and reinforcing the impression of freshness to consumers. The texture and flavor of the tuna may also be preserved, providing a high-quality culinary experience reminiscent of freshly caught fish. Furthermore, the treated tuna may exhibit a significantly extended shelf life compared to untreated tuna, demonstrating the effectiveness of the preservation composition and method in extending the shelf life of fresh or frozen tuna.

These examples illustrate the potential benefits of the fish preservation composition and method disclosed herein. However, it should be understood that these are merely illustrative examples and that the actual results may vary depending on various factors such as the type of fish, the specific components of the preservation composition, the storage conditions, and other factors. Therefore, these examples should not be construed as limiting the scope of the disclosure.

In some aspects, the method for preserving fish may involve injecting the fish with the preservation composition. This may provide a more direct and efficient method of application compared to immersion. For instance, an injection machine may be used to inject a fixed quantity of the preservation composition into the fish under a certain pressure. The injection machine may be preconfigured to deliver the composition at a specific depth within the fish, or to distribute the composition evenly throughout the fish. The specific design and configuration of the injection machine may be tailored to the specific needs of the fish to be preserved and the desired preservation effect.

In some embodiments, after the fish has been treated with the preservation composition and removed from it, the treated fish may be further processed before being packaged and stored. For instance, the treated fish may be cut into smaller pieces, such as cubes or strips, for use in various dishes. This additional processing step may allow for better penetration of the preservation composition into the fish, potentially enhancing the preservation effect. The specific size and shape of the pieces may be determined based on factors such as the intended use of the fish, the type of fish, and the specific requirements of the preservation process.

In other cases, the treated fish may be ground into a paste or a mince for use in dishes such as sushi or fish balls. This additional processing step may allow for better distribution of the preservation composition throughout the fish, potentially enhancing the preservation effect. The specific texture of the ground fish may be determined based on factors such as the intended use of the fish, the type of fish, and the specific requirements of the preservation process.

In some aspects, the fish preservation composition and method may be adapted for use with various types of fish. For instance, the composition and method may be used to preserve fresh or frozen tuna, as described above. However, the composition and method may also be used to preserve other types of fish, such as salmon, cod, haddock, and others. The specific components and concentrations of the preservation composition, as well as the specific steps of the preservation method, may be adjusted depending on the specific needs of the type of fish to be preserved. For instance, fish species that are more susceptible to spoilage may require higher concentrations of the antimicrobial agent or a longer immersion or injection time. Conversely, fish species that are less prone to oxidation may require lower concentrations of the antioxidant or a shorter immersion or injection time.

A number of implementations have been described. Nevertheless, it will be understood that various modifications may be made without departing from the spirit and scope of the disclosure. Accordingly, other implementations are within the scope of the following claims.

### EXAMPLES

Aspects of the present teachings may be further understood in light of the following examples, which should not be construed as limiting the scope of the present teachings in any way.

### Example 1

### Composition #1 for Fish Preservation

Table 1 provides one example of composition #1 for fish preservation, including the different components used in varying quantities, to achieve the desired result. The composition, in one potential embodiment, is a water-based liquid solution.

TABLE 1

| | Composition in percentage by |
|---|---|
| Component | weight (% w/w) |
| Sodium acetate (E262) CH3COONa | 3.5-4.5 |
| Sodium citrate (E331) Na3C6H5O7 | 2.0-3.0 |
| Sodium bicarbonate (E500) NaHCO3 | 1.0-1.5 |
| Sodium ascorbate (E301) C6H7NaO6 | 0.5-1.0 |
| Sodium nitrite (E250) NaNO2 | 0.5 |
| Water | An amount to make the total 100 |

The ratio of liquid to fish is 65% liquid to 35% fish.

The aqueous composition 1 as shown in Table 1 provides antioxidant protection, antimicrobial growth, pH control, which resulted in the enhancement of color, texture and tastes. Consequently, it leads to extended shelf life.

### Example 2

### General Process and Method

In a broad overview, the treatment process involves immersing fish in the liquid mixture at a temperature of +34° F. for one hour. The soaking liquid is formulated using a combination of specific salts, which are sodium acetate, sodium citrate, sodium bicarbonate, sodium ascorbate, and sodium nitrite. These salts are derived from their respective active ingredients and are blended to create the soaking solution for the tuna preservation process. Subsequently, the treated product is vacuum-sealed in bulk and stored in a chiller maintained at a temperature range of +33 to +35° F. for a duration of 24 hours. After this 24-hour period, the product is individually vacuum-sealed and optionally to Individually Quick Freezing (IQF) until reaching a temperature of −35° F.

The application of the above said ingredients primarily involves sequestering iron, thereby preventing the chelation reaction. Chelation is a process wherein a molecule forms a complex with a metal by surrounding and binding to it through coordinated chemical bonds. Sodium citrate's ability to chelate with metal ions arises from its multiple functional groups, including carboxylic acid and hydroxyl groups, capable of interacting with metal ions. The chelation process facilitated by citric acid involves the formation of a complex between the carboxylic acid groups in citric acid and a metal ion. In this complex, the carboxylic acid groups envelop the metal ion and establish coordinate covalent bonds with it. This resulting complex stabilizes the metal ion and hinders its reactivity with other compounds present in the food. This is crucial because metal ions can catalyze reactions that lead to food spoilage, such as oxidation. By chelating with metal ions, citric acid effectively prevents these reactions and extends the shelf life of the food product.

The implementation of this fish preservation process results in a significant extension of the product's shelf life. Typically, the shelf life increases from approximately 2 to 3 days after the product is harvested to about 10 to 12 days. The treatment also improves the organoleptic (taste, smell, texture, flavor, feel, etc.) characteristics of fish for a prolonged period of time, without the above-mentioned disadvantage of the carbon monoxide treatment, that would hide the deterioration of the product.

### Example 3

### Method of Preserving Tuna

Initially, the highest grade fresh caught tuna is filleted into four loins. The four loins include two back loins and two belly loins and the process of filleting includes removal of the meat from the tuna.

Then loins are trimmed to remove excessive fat and remaining bones using the process of deboning and trimming. Thereafter, in the next step, skin is removed from the tuna and the blood lines are removed to improve the appearance and taste of the tuna. If the loins are found too thick (thicker than 4 inches at any dimension), they can be subsequently cut into steaks or portions, which will allow better penetration of the soaking mixture.

The loins or cuts are treated with composition 1 containing sodium acetate, sodium citrate, sodium bicarbonate, sodium ascorbate and sodium nitrite, which are all salts of their related active ingredient. The ratio of liquid to fish is 65% liquid to 35% fish.

The composition 1 has shown to increase the shelf life of tuna and further preserves the color and flavor of the tuna. After the treatment, the treated cuts of tuna vacuum packaged in bulk and placed in a chiller at +33 to +35° F. for 24 hours. The cooling period allows the components to distribute evenly throughout the meat, enhancing their effectiveness in preserving the tuna characteristics.

After the refrigeration period tuna loins or cuts can be optionally further cut into small cubes, strips or ground meat to be applied in different dishes such as in sushi preparation. Or they can be immediately vacuum packed to create a vacuum-sealed environment for freezing and preserving the tuna cuts and to be quickly frozen to −35° F. The tuna can be preserved for up to twenty-four months in a frozen state and in defrosted condition for about 72 hours.

Besides immersion, the treatment solution may also be injected into the tuna loins by means such as an injection machine which can be preconfigured to inject a fixed quantity of the treatment liquid under a certain pressure. The treatment solution composition would remain the same and will consist of water, sodium acetate, sodium citrate, sodium bicarbonate, sodium ascorbate and sodium nitrite.

The treatment of the present disclosure helps in preserving the original color and other organoleptic characteristics of the tuna in frozen condition using a treatment composition described in Table 1. The tuna can be preserved for up to twenty-four months in a frozen state and in defrosted condition for about 72 hours.

When tested finished product, there are only three residual ingredients besides tuna:

| | |
|---|---|
| Sodium Acetate | 3 gr/kg of tuna |
| Sodium Citrate | 0.6 gr/kg of tuna |
| Sodium Nitrite | 0.2 gr/kg of tuna |

The study has shown that using the preservation Composition #1 has effectively maintained or improved the sensory attributes, inhibited the microbial growth, delayed the chemical changes in the fish during the storage, and extended the shelf life.

In various embodiments, the exact composition of the different components can vary. Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art.

The composition described herein can be adapted for use in nearly any environment fish processors. The tuna antioxidant solution composition significantly extends the fresh fish's color retention in both frozen and defrosted states while the storage conditions help in maintaining the overall quality of the fish over time.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, in various embodiments, the same or similar solution and method can be used in the context of preserving various different types of fish in addition to tuna. Accordingly, this description is meant to be taken only by way of example, and not to otherwise limit the scope of this invention.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A fish preservation composition comprising:
an antioxidant;
an antimicrobial agent; and
a pH modifier,
wherein the composition is an aqueous solution comprising sodium acetate, sodium citrate, sodium bicarbonate, sodium ascorbate, and sodium nitrite.

2. The fish preservation composition of claim 1, wherein the sodium acetate is present in a range of 3% to 5% by weight of the composition.

3. The fish preservation composition of claim 1, wherein the sodium citrate is present in a range of 1.5% to 3.5% by weight of the composition.

4. The fish preservation composition of claim 1, wherein the sodium bicarbonate is present in a range of 0.5% to 2% by weight of the composition.

5. The fish preservation composition of claim 1, wherein the sodium ascorbate is present in a range of 0.1% to 1.5% by weight of the composition.

6. The fish preservation composition of claim 1, wherein the sodium nitrite is present in a range of 0.1% to 1% by weight of the composition.

7. The fish preservation composition of claim 1, further comprising an administrative device selected from a prefilled syringe for use in manual injection or auto injection.

8. A method for preserving fish, comprising:
preparing the fish in a desired size and portion;
immersing the fish in an effective amount of a preservation composition for a predetermined time and temperature, wherein the preservation composition comprises an antioxidant, an antimicrobial agent, and a pH modifier;
removing the fish from the composition; and
packaging and storing the treated fish.

9. The method of claim 8, wherein the preservation composition is an aqueous solution comprising sodium acetate, sodium citrate, sodium bicarbonate, sodium ascorbate, and sodium nitrite.

10. The method of claim 9, wherein:
the sodium acetate is present in a range of 3% to 5% by weight of the composition;
the sodium citrate is present in a range of 1.5% to 3.5% by weight of the composition;
the sodium bicarbonate is present in a range of 0.5% to 2% by weight of the composition;
the sodium ascorbate is present in a range of 0.1% to 1.5% by weight of the composition; and
the sodium nitrite is present in a range of 0.1% to 1% by weight of the composition.

11. The method of claim 8, wherein the step of preparing the fish comprises filleting the fish into loins and trimming to remove excess fat, bones, skin, and blood lines.

12. The method of claim 8, wherein the predetermined time is about one hour and the predetermined temperature is about +34° F.

13. The method of claim 8, wherein the step of packaging comprises vacuum sealing the treated fish.

14. The method of claim 13, further comprising a step of storing the vacuum sealed treated fish at a temperature between +33° F. and +35° F. for about 24 hours.

15. The method of claim 14, further comprising a step of freezing the vacuum sealed treated fish to a temperature of about −35° F.

16. A system for preserving fish, comprising:
a container for holding a fish preservation composition;
a fish preservation composition disposed within the container, the composition comprising an antioxidant, an antimicrobial agent, and a pH modifier; and
an administrative device for applying the fish preservation composition to fish.

17. The system of claim 16, wherein the fish preservation composition is an aqueous solution comprising sodium acetate, sodium citrate, sodium bicarbonate, sodium ascorbate, and sodium nitrite.

18. The system of claim 17, wherein:
the sodium acetate is present in a range of 3% to 5% by weight of the composition;
the sodium citrate is present in a range of 1.5% to 3.5% by weight of the composition;
the sodium bicarbonate is present in a range of 0.5% to 2% by weight of the composition;
the sodium ascorbate is present in a range of 0.1% to 1.5% by weight of the composition; and
the sodium nitrite is present in a range of 0.1% to 1% by weight of the composition.

19. The system of claim 16, wherein the administrative device is selected from a prefilled syringe for manual injection or an auto injector.

20. The system of claim 19, further comprising a refrigeration unit configured to maintain the fish preservation composition at a temperature between +33° F. and +35° F.
